(19) United States
(12) Patent Application Publication
(10) Pub. No.: US 2011/0235589 A1
(43) Pub. Date: Sep. 29, 2011

(54) Communication System for Voice-Over Internet Protocol Using License-Free Frequencies and a Mobile Telephone

(76) Inventors: Johnny Kristensen, Horsholm (DK); Rasmus Stromsted, Copenhagen (DK)

(21) Appl. No.: 13/153,528

(22) Filed: Jun. 6, 2011

Related U.S. Application Data
(62) Division of application No. 12/933,194, filed on Dec. 13, 2010.

(30) Foreign Application Priority Data
Mar. 18, 2008 (EP) 08005000.8

(51) Int. Cl. H04W 4/00

(52) U.S. Cl. 370/328

(57) ABSTRACT

In a communication system comprising—at least one mobile telephone (1) having Bluetooth capability and software-implementing possibilities, —at least one Bluetooth access point (6) providing an internet connection, —at least one internet-connected VoIP server (8) providing call connections in the form of PSTN, GSM, VoIP, etc., there is provided a software-implemented client (11,12,13,18) functioning as a call centre and controlling outgoing and incoming communications to be directed via the Bluetooth connection (5) between the mobile telephone (1) and the Bluetooth access point (6) and via the internet (7) to and from the VoIP server (8) controlling the call connections. This provides the possibility of making calls at a reduced price or even free.

### TECHNICAL FIELD

The present invention relates to a communication system, which provides low-cost communication via the internet whenever an internet connection is available.

### BACKGROUND ART

In communication systems of this kind it is known to provide voice-over internet protocol connections using WiFi hotspots, internet-connected computers, etc. One example of such a system is the well-known Skype® concept, which, however, requires that both ends of the call to be set up comprises internet-connected PC's. In an alternative, the one end connection is provided using the so-called SkypeOut®, i.e. providing local connection to an ordinary PSTN telephone or GSM mobile telephone.

### DISCLOSURE OF THE INVENTION

Based on this prior art, it is the object of the present invention to provide a communication system which can be implemented in a mobile telephone, a PDA or similar, said mobile telephone having Bluetooth capability, without necessarily having a PC connected to the internet associated with the mobile telephone, and yet establishes a user-friendly system only requiring the presence of a Bluetooth internet access point, be it a private or public hotspot, and automatically providing low cost or free communication from the mobile telephone to the desired destination. This object is achieved with a communication system of said kind, which according to the present invention comprises the features set forth in claim 1. With this arrangement the communication to and from the mobile telephone is controlled by the software-implemented client in such a way that the user does not have to interfere with the function in order to obtain a connection to the desired destination, and the communication is set up using license-free frequencies, such as Bluetooth, without any costs related to the GSM function of the mobile phone.

If the mobile phone has Symbian or other non-proprietary, e.g. Windows mobile, platforms, the software-implemented client may be installed in the mobile telephone. If, however, the mobile telephone is an older type of mobile phone running proprietary software, the major part of the software-implemented client may have to be installed in a dedicated Bluetooth access point, and only a minor part of the software-implemented client is installed in the mobile telephone using JAVA or similar.

### BRIEF DESCRIPTION OF THE DRAWINGS

In the following detailed part of the present description, the invention will be explained in more detail with reference to the exemplary embodiments of a communication system in accordance with the invention shown in the drawings, in which

FIG. 1 schematically shows a communication system in accordance with the present invention,

FIG. 2 schematically shows the provision of a communication connection in accordance with a first aspect of the invention using a JAVA client in the mobile telephone and a Bluetooth access point with built-in voice-over internet protocol client, a Bluetooth headset is used for audio.

FIG. 3 schematically shows the provision of a communication connection in accordance with a second aspect of the invention using a Symbian VOIP client in the mobile telephone and a simple Bluetooth internet access point,

FIG. 4 schematically shows the provision of a communication connection in a situation where no Bluetooth access point is available and where a call-back function in the VOIP server provides a low cost GSM connection between the mobile telephone and the VOIP server and further on to the desired destination, and

FIG. 5 schematically shows an overall view of a communication system implementing a number of the possible connection possibilities provided by the present invention.

### DESCRIPTION OF THE PREFERRED EMBODIMENTS

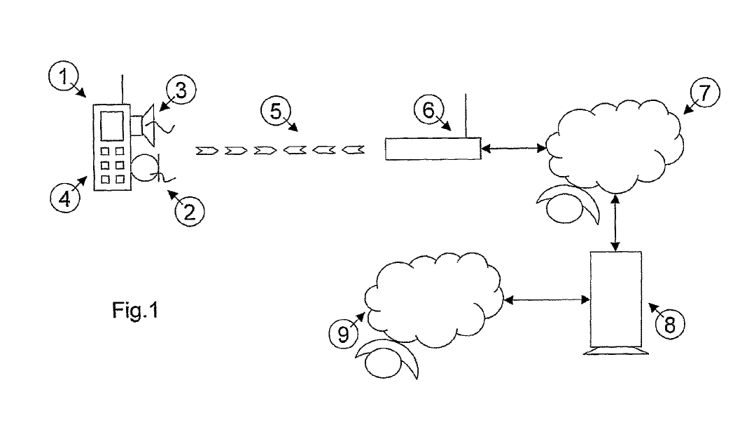

The communication system schematically shown in FIG. 1 comprises a mobile telephone 1 including a microphone 2, a loudspeaker 3, a keyboard 4 and a Bluetooth connection system 5, said mobile telephone 1 being connectable to a Bluetooth access point 6 providing internet connection 7 for the mobile telephone 1. In order to provide a connection further on to the destination, a voice-over internet protocol server 8 is provided in the internet, said server function to connect the mobile telephone 1 to the desired destination.

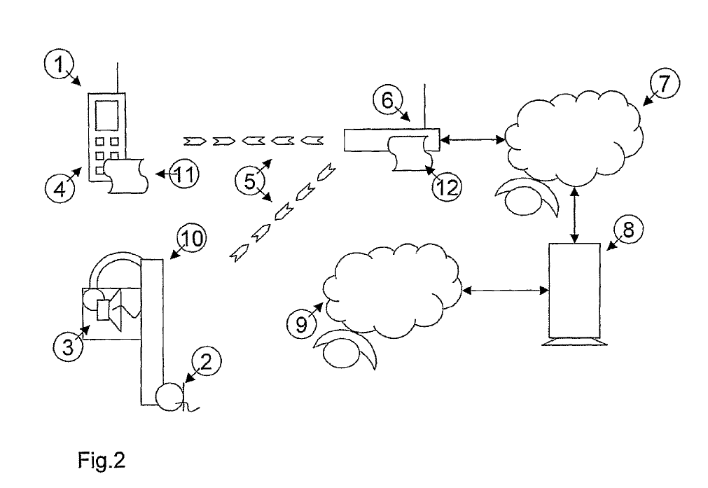

In FIG. 2 the communication setup for an older type of mobile phone 1 running proprietary software is shown schematically. The mobile phone is provided with a JAVA software client 11, which is installed in the mobile phone 1 in the traditional way, either by downloading directly from a service provider or by transferring from a personal computer. The installed software client 11 establishes a connection 5 to the Bluetooth access point 6, whereby data can be transferred between the mobile phone 1 and the access point 6. The software client 11 in the mobile phone 1 provides a remote control of the functions in the access point 6, said access point having a built-in VOIP client 12, which is able to provide a connection to a VOIP server 8 via the internet 7. When making a call from the mobile phone 1, the software 11 in the mobile phone 1 sends data to the access point 6 via the Bluetooth connection 5 in order to make the built-in VOIP client 12 call the desired destination via the internet 7 and the VOIP server 8. The VOIP server 8 is connected to the public-switched telephone network (PSTN) 9, whereby the mobile phone 1 is able to call any ordinary telephone and any such ordinary telephone is able to call the mobile phone 1. As soon as a connection is established between the mobile phone 1 and the desired destination, a Bluetooth audio connection 5 is provided between the access point 6 and a Bluetooth headset 10, and the data connection 5 between the mobile phone 1 and the access point 6 remains open in order to be able to send SMS or other data-based information between the mobile phone 1 and the access point 6 and the internet 7.

Because of the limited functionality of the mobile Java, and capacity of older mobile telephones 1, the entire VOIP functionality will be located in the access point 6. The functionality of the Java client 11 will be of remote controlling the access point 6. It is at present not possible to control the audio devices of the mobile telephone 1 through Java, and therefore the end-user will have to use a Bluetooth headset 10 for the audio communication.

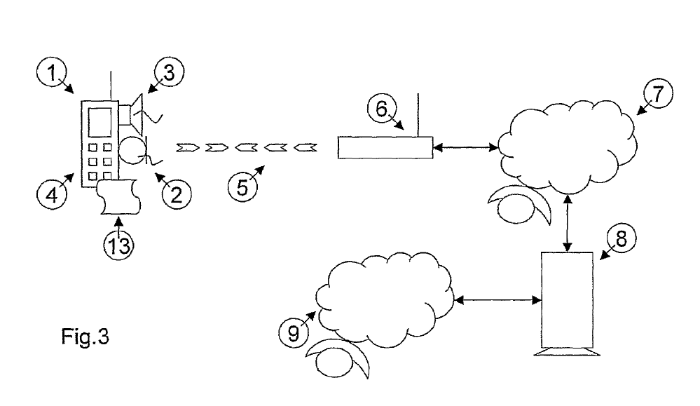

In FIG. 3 a corresponding situation as shown in FIG. 2 is shown, however, the mobile phone 1 runs a non-proprietary OS system and thus the software client 13 providing VOIP is completely installed in the mobile phone 1 and the Bluetooth access point 6 does not need to have any part of the software client installed and will only function as an access point without any functionality relating to the provision of the VOIP connection. The software client 13 installed in the mobile phone 1 provides a connection to the Bluetooth access point 6 and the mobile phone receives a IP address via the Bluetooth connection. Via this IP address the software provides a connection to a VOIP server 8 via the internet 7 and this server 8 is connected to the public-switched telephone network 9 (PSTN), whereby the mobile phone 1 is able to call any ordinary telephone and any ordinary telephone is able to call the mobile phone 1.

As soon as a connection is established between the mobile phone 1 and the VOIP server 8, call-connectivity is provided between the mobile phone 1 and the PSTN 9.

In a situation, in which no Bluetooth connection 5 is available for the mobile telephone, the mobile telephone may, when provided with a SIM card to a standard GSM network 16, send an SMS or GPRS request 14 to an internet-based server 17, said server 17, based on the SMS/GPRS data 14 received, providing a call to the desired destination 15 and a call-back to the mobile telephone 1, thus providing a connection between the destination 15 and the mobile telephone 1 at a reduced price.

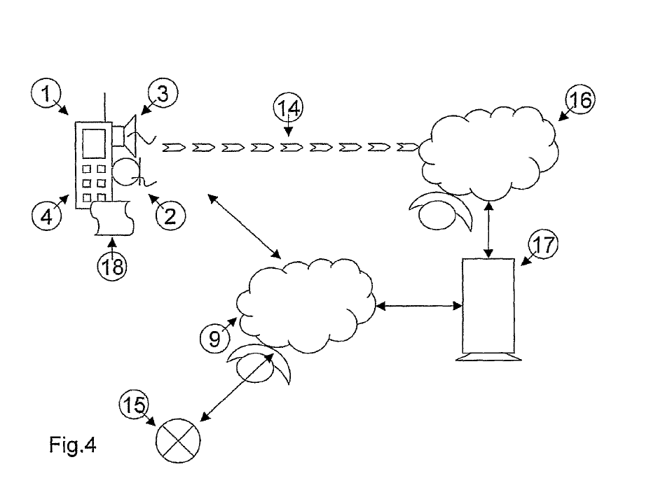

As shown in FIG. 4, this situation is handled by the mobile phone 1 sending, using the GSM network 16, an SMS or GPRS request 14 to the internet-based server 17, and based on the information in this request the internet server 17 provides a connection to the destination 15 using VOIP, PSTN, GSM, etc., and a call-back to the mobile phone 1, whereby a connection is established between the destination and the mobile phone, possibly at a reduced price due to a special low-price for the GSM connection between the server 17 and the mobile phone 1.

Furthermore, the price may be reduced by shootably selecting the connection between the internet server 17 and the destination 15.

When negotiating terms and prices with a GSM carrier, it is usually possible to negotiate a special low cost structure so it will be possible to communicate at a lower price between own subscriptions, i.e. fixed to cell, or cell to fixed. By using this low cost model, it will be possible to open a low cost call-back line, and use this to dial through the VOIP server.

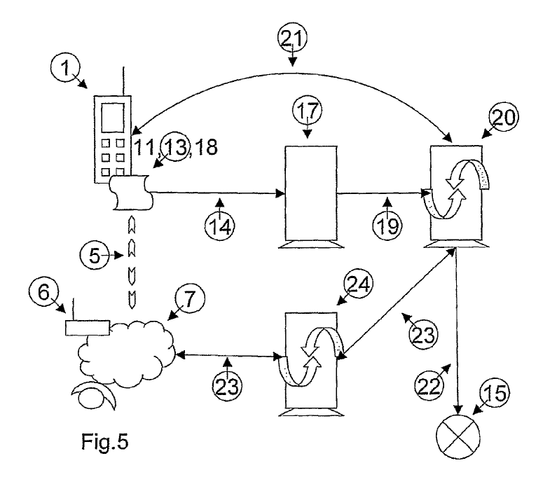

In FIG. 5 a more complete system has been indicated schematically in order to give an overview of the total system providing the communication system in accordance with the present invention. This system comprises the mobile telephone 1, which may be connected to the Bluetooth access point 6 providing an internet connection to the VOIP server 24 providing the connections further on to the public-switched telephone network 22 via a PSTN gateway 20. If the connection to the Bluetooth access point 6 is not available for the mobile telephone 1, the client 11,13,18 installed in the mobile telephone 1 sends an SMS or GPRS request 14 to a call-back server 17, which requests the PSTN gateway 20 to call the destination 15 and call back to the mobile phone 1 at a reduced price.

The invention provides the possibility of using a mobile telephone having Bluetooth capability and having Symbian or another non-proprietary operational system for installing a software-implemented client, whereby the mobile phone automatically seeks to provide any outgoing calls via possible present Bluetooth access points accessible by the Bluetooth capability of the mobile telephone. In this respect, the software-implemented client provides the possibility of emulating the Bluetooth access point connection to provide an IP address for the mobile telephone and bringing the Bluetooth connection to function as any other data communication connection having an IP address, such as WiFi, DUN (dial-up network), etc.

In use, the communication system provides call connections for a mobile telephone 1 having Bluetooth capability and having a software-implemented client installed. The software-implemented client provides the possibility of detecting the presence of Bluetooth access points 6 and provides connections to such access points in order to register the mobile telephone 1 in the internet with a IP address. Using this IP address, connections to and from the mobile telephone can be provided through a VOIP server 8 in the internet, said VOIP server 8 establishing call connections in the form of any of PSTN, GSM, VOIP, and possible other types of call connections. When moving around, the client installed in the mobile telephone 1 continuously performs a detection of possible access to a Bluetooth access point having connection to the internet, and thus continuously tries to be registered with an IP address in the internet, such that connections to and from the mobile telephone may be established using the Bluetooth connection and the IP address, under control by said VOIP server 8 and the software-implemented client.

In the case that no Bluetooth access point is detected and the mobile telephone is instructed to make a call, the software-implemented client may automatically send a SMS message to a call-back module in the VOIP server 8, said SMS message containing information relating to the desired call, and based on this message a call-back module in the VOIP server 8 establishes a connection to the desired destination and performs a call-back to the mobile telephone 1 in order to make said connection between the mobile telephone 1 and the desired destination. In this respect, the VOIP server 8 call-back module is preferably programmed to search for the lowest cost connections for the call.

1. A method of providing call-back connection to a mobile telephone provided with a software-implemented client, comprising steps of:
a) initiating a call by the software-implemented client by sending a SMS or GPRS request from the mobile telephone to a VOIP server, wherein said SMS or GPRS request contains information relating to a desired call,
b) establishing a connection to a desired destination by the VOIP server based on the information relating to the desired call,
c) performing a call-back by the VOIP server to the mobile telephone to establish a connection between the desired destination and the mobile telephone.

2. A method of providing call-back connection to a mobile telephone in accordance with claim 1, wherein a call-back module of the VOIP server searches for the lowest cost connections for the desired call.

3. A method of providing call-back connection to a mobile telephone in accordance with claim 1, wherein the VOIP server provides the connection to the desired destination using one of {VOIP, PSTN, GSM}.

4. A method of providing call-back connection to a mobile telephone in accordance with claim 1, wherein the software-implement client is further adapted to:
d) continuously detecting the presence of Bluetooth access points accessible for connection to the internet,
e) establishing an IP address via such detected Bluetooth access points whereby connections to and from the mobile telephone can be established using Bluetooth, said IP address and the VOIP server.
